(19) United States
(12) Patent Application Publication
(10) Pub. No.: US 2023/0166986 A1
(43) Pub. Date: Jun. 1, 2023

(54) SOLAR-POWERED WATER PURIFICATION AND DECONTAMINATION GEL COMPOSITIONS

(71) Applicant: The Trustees of Princeton University, Princeton, NJ (US)

(72) Inventors: Xiaohui XU, Princeton, NJ (US); Rodney D. PRIESTLEY, Princeton, NJ (US)

(21) Appl. No.: 17/921,884

(22) PCT Filed: Apr. 27, 2021
(86) PCT No.: PCT/US2021/029422

§ 371 Date: Oct. 27, 2022

Related U.S. Application Data
(60) Provisional application No. 63/015,855, filed on Apr. 27, 2020.

(51) Int. Cl. C02F 1/28; C02F 1/32; B01J 20/24; B01J 20/26; B01J 20/28; B01J 20/32; B01J 20/34

(52) U.S. Cl. CPC C02F 1/288; C02F 1/32; C02F 1/285; C02F 1/286; B01J 20/24; B01J 20/26; B01J 20/28047; B01J 20/3272; B01J 20/3441; C02F 2303/04; C02F 2305/08; C02F 2101/32

(57) ABSTRACT

The present technology relates to present technology relates to materials, methods, processes and systems for clean water production—in particular, to unique hydrogels that can purify and decontaminate water, providing an effective and sustainable way to turn contaminated water into potable water. The present technology also contemplates methods of making such gels, methods of purifying water and providing purified water from contaminated water, and contemplates systems for accomplishing water purification in a rapid, cost-effective and environmentally sustainable way.

### CROSS REFERENCE TO RELATED APPLICATIONS

This application relates to and claims priority from U.S. Provisional Patent Application Ser. No. 63/015,855 filed Apr. 27, 2020, the entire disclosure of which is hereby incorporated by reference.

### BACKGROUND

The present technology relates to materials, methods, processes and systems for clean water production — in particular, to unique hydrogels that can purify and decontaminate water, providing an effective and sustainable way to turn contaminated water into potable water; as well as to methods, processes and systems for accomplishing water purification.

The global demand for clean and safe water is ongoing, and is expected to continue to grow well into the twenty-first century. According to the World Health Organization (WHO), more than 50% of the world's population will live in a water-stressed environment by 2025. Lack of access to clean water threatens human health on a massive scale. Unsafe drinking water causes more than one million deaths worldwide each year from diarrhea. When supply cannot keep up with demand, precious energy resources are strained, further exacerbating shortages.

Using renewable solar energy to produce clean water from contaminated water is an attractive and environmentally friendly method to solve the long-standing clean water shortage crisis. Current technologies use nanostructured solar absorbers to heat surface water for steam generation, following by collecting condensate. However, these methods and processes have their drawbacks, which are serious enough to render them insufficient to meet practical demands. These include a low water collection rate, the disadvantage of being highly solar intensity dependent (which can lead to unpredictable results based on location and weather conditions), diminished efficiency with treatment of increasingly contaminated water, and significant requirements for extra energy to condense steam. All of these disadvantages hinder the practical application of these current technologies.

Therefore, an ongoing need exists for materials and processes that can produce clean water from contaminated water efficiently and predictably. Those that can do so through sustainable methods are particularly desirable.

### SUMMARY

In certain embodiments, the present technology is directed to a gel composition comprising:
(a) a 3D microporous gel skeleton comprising Poly(N-isopropylacrylamide) (PNIPAm), the 3D microporous gel skeleton having an outer surface;
(b) a plurality of polydopamine (PDA) nanoparticles adhered to the outer surface of the 3D microporous gel skeleton, the PDA nanoparticles comprising one or more catechol groups; and
(c) a sodium alginate (SA) layer coating the 3D microporous gel skeleton and the plurality of PDA nanoparticles.

In certain embodiments, a gel composition herein comprises:
(a) a 3D microporous gel skeleton comprising Poly(N-isopropylacrylamide) (PNIPAm), the 3D microporous gel skeleton having an outer surface;
(b) a plurality of polydopamine (PDA) nanoparticles adhered to the outer surface of the 3D microporous gel skeleton, the PDA nanoparticles comprising one or more catechol groups;
(c) a metal configured to coordinate with the one or more catechol groups of the PDA; and
(d) a sodium alginate (SA) layer coating the 3D microporous gel skeleton and the plurality of PDA nanoparticles.

In other embodiments, the present technology is directed to a method of producing a water purifying gel composition, comprising the steps of:
(a) providing a 3D microporous gel skeleton;
(b) immersing the 3D microporous gel skeleton into a solution comprising dopamine to obtain a 3D microporous gel skeleton with attached polydopamine (PDA); and
(c) immersing the 3D microporous gel skeleton with attached PDA into a solution comprising sodium alginate, to obtain the water purifying gel composition.

In other embodiments, the present technology is directed to a method of purifying water, the method comprising the steps of:
(a) obtaining a gel composition comprising: (i) a 3D microporous gel skeleton; (ii) a plurality of polydopamine (PDA) nanoparticles adhered to the outer surface of the gel skeleton; and (iii) an outer layer comprising sodium alginate;
(b) immersing the gel composition into an amount of contaminated water, the contaminated water comprising water and a contaminant;
(c) allowing the outer layer of the gel composition to repel at least some of the contaminant while the 3D microporous gel skeleton absorbs at least some of the remaining, less-contaminated water;
(d) removing the gel composition from the contaminated water;
(e) exposing the gel composition to sunlight such that the sunlight is converted to thermal energy, thereby raising the temperature of the gel composition to a temperature above the lower critical solution temperature of the gel composition and causing a phase transition of the gel composition from hydrophilic to hydrophobic; and
(f) allowing the less-contaminated water absorbed in the gel skeleton to be expelled from the gel composition.

In other embodiments, the present technology is directed to system for purifying water, the system comprising: a gel composition comprising: (i) a 3D microporous gel skeleton; (ii) a plurality of polydopamine (PDA) nanoparticles adhered to the outer surface of the gel skeleton; and (iii) an outer layer comprising sodium alginate.

### BRIEF DESCRIPTION OF THE DRAWINGS

FIG. 1A shows exemplary steps in a water purification procedure discussed herein, including water adsorption, clean water generation, and resultant water in liquid and vapor form. FIG. 1B shows another aspect of a process herein, in particular the sunlight-driven SAG technology for water production, based on the phrase transformation (swelling and deswelling) of PNIPAm under natural or artificial sunlight. The SAG harvests large quantities of clean water from contaminated water at or around atmospheric pressure.

FIG. 2 shows details of embodiments herein as follows: FIG. 2A shows preparation of a 3D solar absorber gel at room temperature; FIG. 2B shows scanning electron microscopy (SEM) images of polydopamine (PDA) decorated gel under different magnifications, demonstrating the microporous architecture and pore size distribution. FIG. 2C shows SEM images of a 3D solar absorber gel prepared according to an embodiment herein, and energy dispersive X-ray spectroscopy of Cu, Na elemental mapping images, indicating the successful SA coating.

FIG. 3 shows clean water production of a 3D gel under sunlight irradiation as follows: FIG. 3A: oil-contaminated water (cyclohexane-in-water emulsion); FIG. 3B: bacteria-containing water (using yeast as a model); FIG. 3C: organic dye-containing wastewater (Rhodamine 6G); and FIG. 3D: reusability of 3D gel for water production from R6G polluted water.

FIG. 4 shows preparation and morphology of an SAG as discussed herein. FIG. 4A shows preparation of the SAG at room temperature. FIG. 4B shows pore size distribution of a PNIPAm-PDA hybrid gel. FIG. 4C shows scanning electron microscopy (SEM) images of the PDA decorated gel under different magnifications, which demonstrate macroporous architecture. FIG. 4D is an SEM image, energy-dispersive X-ray spectroscopy of C, O, Cu and Na elemental mapping images, and cross-sectional image of SAG.

FIG. 5 shows mechanical, wettability. and component characterization of a SAG as discussed herein. FIG. 5A show the results of a non-cycle fatigue test on the PNIPAm gel at a compressive strain of 80%. FIG. 5B shows reversible compressive stress-strain curves of a SAG at a compressive strain of 80%; the insets are photographs of a compression-decompression test cycle. FIG. 5C shows optical images showing the dynamic wetting behaviors of a water droplet (˜30 μL) atop SAG (top), PDA-modified PNIPAm gel (middle), and PNIPAm gel (bottom) at room temperature. FIG. 5D shows O 1 s, N 1 s and C 1 s XPS spectra of the samples.

FIG. 6 shows light-trigged water release performance as follows: FIG. 6A shows DSC thermogram of swollen PNIPAm, PNIPAm-PDA, and SAG. FIG. 6B shows UV-vis-NIR absorbance spectra of PNIPAm, PNIPAm-PDA, and SAG. FIG. 6C shows surface temperature change of various gels over time under one sun illumination. FIG. 6D shows IR images of the 3D porous gel under one sun irradiation (“illumination” and “irradiation” are used interchangeably herein). FIG. 6E shows mass loss over time for a SAG herein versus pure water. FIG. 6F shows collection rates in kg/m² hour of a system herein.

FIG. 7 shows results of the evaluation of wastewater remediation. FIG. 7A shows a schematic of clean water generation of an exemplary SAG from dye-contaminated water. FIG. 7B shows UV-vis adsorption of simulated R6G-contaminated water and the generated water by SAG under one sun illumination. FIG. 7C shows the concentration of Pb²⁺ in water purified by an SAG herein. The inset image shows the changes of Pb²⁺ concentration after the second SAG treatment. FIGS. 7D-E show digital and microscopy photographs of SDS-stabilized cyclohexane-in-water emulsion (FIG. 7D) and yeast solution (FIG. 7E) before and after treatment with an SAG herein.

FIG. 8 shows natural sunlight-driven clean water generation in accordance with embodiments herein. FIGS. 8A-B show the SAG purification system floating atop Carnegie Lake (Princeton, N.J.). FIG. 8B shows water collection of an SAG system under natural sunlight. FIG. 8C shows the surface temperature of an exemplary SAG under natural sunlight. FIGS. 8D-F show optical images of Carnegie Lake water (FIG. 8D, showing microbes) and water purified by a method herein (FIG. 8E). FIG. 8F shows the conductivity of the Carnegie Lake water before and after purification by a SAG herein.

FIG. 9 shows the physical contrast between the pure PNIPAm gel (e.g., FIGS. 9A, 9C and 9E) which is completely or substantially transparent, and the final SAG in certain embodiments (e.g., FIGS. 9B, 9D and 9F) which is darker, e.g., black or substantially black in visual appearance, due to the deposition of the PDA. After coating of PDA and SA, the darker colored gel can maintain at least substantially the original shape of the PNIPAm gel, due to the mild modification processes herein. Moreover, the size and shape of the PNIPAm gel can be adjusted by the mold used for gelation. For example, FIGS. 9A and 9C show the gels in substantially cylindrical form, with diameters of 1 to 4 cm and heights of 0.5 to 2.5 cm. FIG. 9E also shows a substantially cuboid structure.

FIGS. 10A-B show SEM images of an exemplary PNIPAm gel after freeze-drying, indicating a porous structure with an average pore diameter of around 50 μm and a smooth polymeric wall with thickness of approximately 1 μm. FIGS. 10C-E show elemental-distribution mapping with energy-dispersive X-ray spectrometry (EX) that reveals a uniform distribution of C, N, O elements in the PNIPAm gel.

FIG. 11 shows SEM images of PNIPAm-PDA samples according to embodiments herein and corresponding EDX images.

FIG. 12 shows cross-sectional images of SEM images of exemplary SAG after cutting.

FIG. 13A shows XPS of PDA, the elastic PNIPAm, PNIP AM-PDA, and solar absorber gels. FIG. 13B shows FTIR of the PNIPAm before and after PDA functionalization.

FIG. 14A shows IR images of a SAG herein under 1 sun irradiation at 0 minutes, 10 minutes, 25 minutes, and 30 minutes. FIG. 14B shows water releasing from the SAG under light radiation.

FIGS. 15A-D show, sequentially, the appearance of an SAG herein upon physical deformation and then release; as can be seen the SAG shows high elasticity without breakage.

FIG. 16 shows UV-Vis absorption of solar driven water collection from: 4-Nip solution (FIG. 16A); and MO solution (FIG. 16B). The solar absorber gels herein showed selective absorption behavior for the three organic contaminants. This is mainly ascribed to two reasons: the surface charge and molecular size of dyes. Specifically, the size of MO is smaller than R6G and larger than 4-Nip. It is easy for smaller molecules to diffuse into and out of gel. On the other hand, electrostatic interactions can influence the mobility of contaminants. In certain embodiments, the PDA in the polymeric networks is synthetically charged. Thus, although some dye molecules could enter the gel, they will generally be trapped by the PDA, resulting in a higher concentration of negatively charged dyes than positively charged dyes in gel-generated water.

FIG. 17A shows UV-Vis adsorption of generated water from R6G solution and FIG. 17B shows the reusability of the gel for clean water generation from R6G-containing water. The inset of FIG. 17B shows the shape recovery of the 3D porous gel after 10 times of the swelling-deswelling process. These drawings demonstrate that the regenerated solar absorber gel retains at least 90% of its original absorption capacity after 10 adsorption-desorption cycles. After the 10^{th} cycle, the released water from the gel becomes noticeably lighter in color, further confirming the high adsorption capacity and good cycle stability of the present gels.

FIG. 18 shows the stability test results of an exemplary SAG (left) and PNIPAm-PDA gel (right) in water under 1.5 hours sonication and the DLS measurement of the mixture. PDA was adhered to a polymeric network and then chelated with Cu²⁺ crosslinked SA polymer. The introduction of SA endows the PDA with excellent stability and high adsorption property. As shown here, after taking out gel from water, substantially no leakage of PDA is observed using long time ultrasonication. In contrast, the water after removing the PNIPAm-PDA gel without SA modification was not clear visibly. DLS measurement indicated the light brown color was due to leakage of PDA from the skeleton of gel even under 1.5 hours sonification. Therefore, the SA is shown to play a key role in maintaining the high stability and adsorption of the gel.

FIG. 19A shows size distribution of cyclohexane-in-water emulsion and FIG. 19B shows DLS measurement of collected water from cyclohexane. The cyclohexane droplets in the original SDS-stabilized cyclohexane-in-water emulsion ranged from 1 to 20 μm. In the produced water from the cyclohexane, the peak around below 10 nm is contributed by the water-soluble SDS rather than the cyclohexane droplet. This indicates that the gels herein can effectively absorb water while filtering off all of the oil droplets, and then release the clean water under sunlight.

FIG. 20 shows solar driven water collection from SDS-stabilized petroleum ester-in-water emulsion (FIG. 20A) and hexane-in-water (FIG. 20B) and their DLS measurements, respectively.

FIG. 21 shows the light to heat conversion of polymer chain in a SAG under sunlight radiation, including a close up of the swollen SAG, SAG radiated by sunlight, and shrunken SAG (after purified water has been expelled). In an exemplary SAG platform, photothermal PNIPAm chains are hydrated and surrounded by water molecules at a temperature below the LCST, for example, room temperature. When irradiated by the sunlight, the PDA on the PDIPAm chains can convert light energy to heat energy, heating up the system above the LCST of PNIPAm. The SA can function as a thermal insulator to reduce heat loss to achieve the confinement of thermal energy within the hydrogel. The heated PNIPAm chains can then change into hydrophobic and squeeze out the absorbed water via volume shrinkage, resulting in the unprecedented efficiency of pure water production rate under sunlight. Unlike the known methods that involve heating the water to a high temperature to form vapor, the methods herein directly heat the polymer network above the LCST by attached PDA on the network.

### DETAILED DESCRIPTION

All percentages expressed herein are by weight, unless otherwise indicated. It is noted that throughout the present disclosure, reference made to any numbered items in the Figures are for example only, and the embodiments herein are not limited to the depictions of such items in the Figures.

In various embodiments, the present technology is directed to gels or gel compositions, including but not limited to 3D microporous gels. As used herein, “3D” or “3 dimensional” indicates an interconnected polar structure, in contrast to a merely flat structure such as a film.

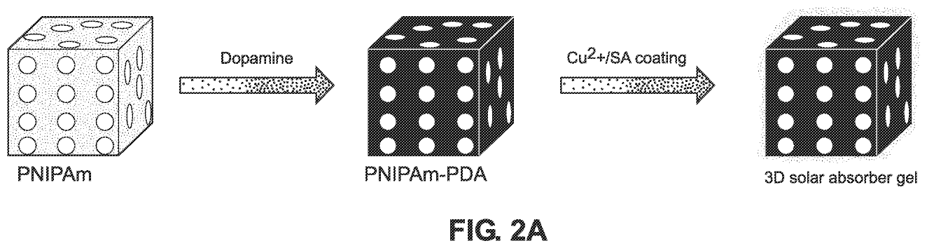

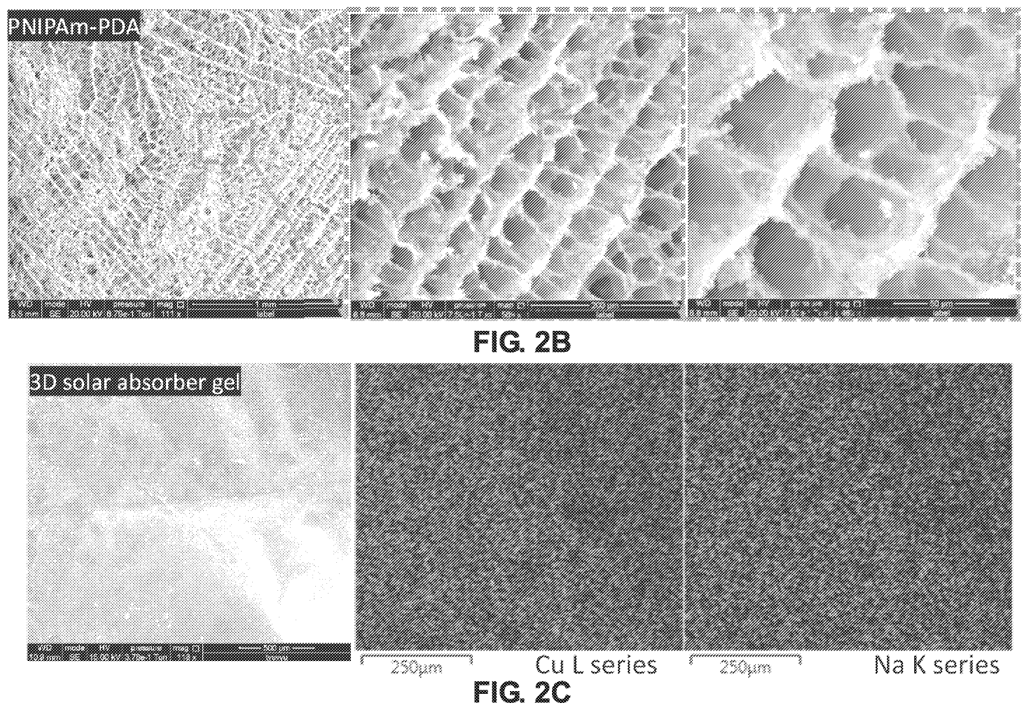

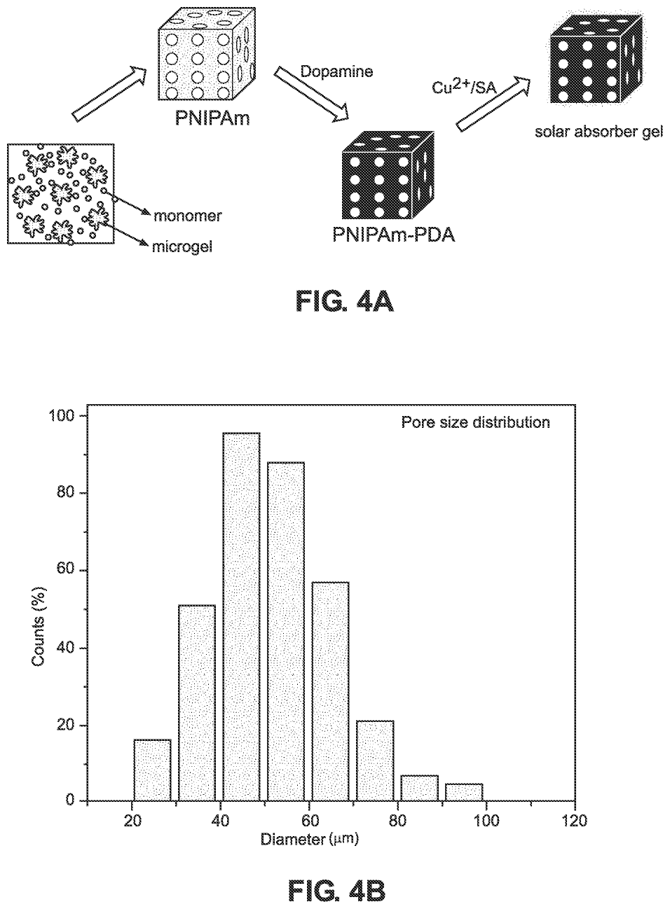

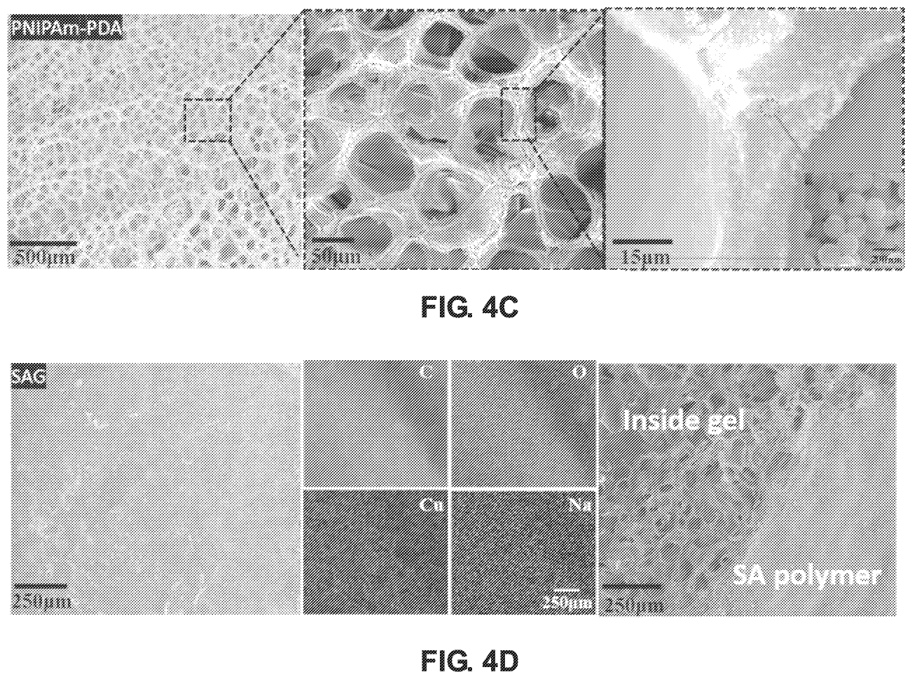

As used herein, “gel” means a sol in which the solid particles are meshed such that a rigid or semi-rigid mixture results. Examples of gels include, but are not limited to: aerogel, hydrogel or xerogel. As used herein, “hydrogel” means a gel prepared using water as solvent. Hydrogels are water-swollen polymeric materials that maintain a distinct three-dimensional structure. As used herein, “gel composition” means any composition comprising in whole or in part, a gel. As used herein, “gel skeleton” means the highly porous underlying three-dimensional structure of a gel composition, having walls and spaces herein that other compositions can attach to or be adsorbed to, or be absorbed within. As used herein, “microporous” means having small holes, for example, 20 to 100 μm, 40 to 60 μm or about 50 μm, as shown, e.g., in FIGS. 2 and 4.

As used herein, “absorbed” means the state wherein two materials are combined, such that one material is taken internally into another. As used herein, “adsorbed” means the state wherein one material sticks to the surface of another, such that one material coats the surface of another.

As used herein “substantially” means within 10% of a quantitative value. For example, “substantially equal to” means within 10% of the same value; “substantially full” or “substantially empty” mean within 10% of full or empty, respectively.

As used herein, “contaminated water” means water that contains one or more contaminants. As used herein, “purified” or “pure” water does not mean water completely free from contaminants, but is used to refer to water that has had any amount of contaminant reduced, e.g., through the processes discussed in the present disclosure. Thus, in certain embodiments, the methods, processes or systems herein may refer to “contaminated water” going in, and “pure” or “purified” water coming out, meaning that the second includes fewer contaminants than the first. Similarly, in certain embodiments herein, methods of purifying water refer to those methods that can decrease the contaminants in the water, rendering them closer to being potable, but not necessarily completely pure. Thus, in certain embodiments, the methods and processes herein can achieve increasingly pure water even after multiple repetitions of the steps recited herein.

As used herein, “contaminant” means any substance that can adulterate or pollute water, and in various embodiments herein, includes but is not limited to any of the following: a hydrocarbon, a metal (for example, a heavy metal such as mercury or lead ion), a salt, a drug, a biological contaminant such as a strain of bacteria, a dye, a particulate, dirt, a chemical (for example, nitrogen), or naturally occurring organic matter.

As used herein, “sunlight” means solar energy, and can include either natural sunlight (obtained from the sun) or artificial sunlight (obtained from human generated light sources such as bulbs or lamps).

As used herein, “phase change” or “conformational change” refers to a change from hydrophilicity to hydrophobicity, or vice versa.

As mentioned above, current processes for purifying water have many disadvantages. Included among them are high costs, high energy input requirements, and limited end products. The embodiments herein are advantageous in that as hydrogel-based systems, they are environmentally friendly, have a low footprint, and are scalable and modular.

In certain embodiments, poly(N-isopropyl acrylamide) (PNIPAm) hydrogels have been developed herein, that can absorb and release water via hydrophilic/hydrophobic switching at the lower critical solution temperature (LCST) (˜33° C.)—a temperature readily achieved using natural sunlight. In order to be able to harvest solar energy, in certain embodiments herein the PNIPAm hydrogels are modified with an efficient solar absorber. In the embodiments, Polydopamine (PDA) has been used in such a manner. PDA is a melanin-based polymer that exhibits broadband solar absorption and noble photothermal conversion efficiency. PDA offers additional properties of benefit for water purification; among them, the presence of amino groups and aromatic rings, which endow PDA with the ability to remove heavy metal ions and organic dyes through chelation and hydrogen bonding.

In certain embodiments, the present technology is directed to hybrid hydrogels that are particularly useful for solar water purification and decontamination. In certain embodiments, a hydrogel herein comprises a 3D solar absorber gel that can take full utilization of renewable solar energy for high-efficiency water purification and production. Exemplary materials can integrate all the desirable optical (polydopamine), thermal (PNIPAm), and wetting (alginate) properties to solve the long-standing clean water shortage crisis. Such sunlight driven gels can significantly improve clean water production efficiency, inspiring new strategies for superior water treatment materials.

### Photoresponsive Solar Absorber Gel (SAG)

In certain embodiments, the present technology is directed to a photoresponsive solar absorber gel (SAG) having high elasticity, that is configured to allow for repeated cycles of clean water production from contaminated sources. Such SAG can, in certain embodiments, be fabricated as follows: PDA and cross-linked sodium alginate (SA) can be deposited atop a microporous PNIPAm hydrogel. The SA layer has been found to improve salt rejection of the SAG—that is, repelling the salt rather than absorbing it.

In certain embodiments, the terms, “gel,” “gel composition,” “hydrogel” and “SAG” are used interchangeably herein to refer to the embodiments of the technology herein, including the inventive compositions that are used to sanitize and purify contaminated water, as well as the attendant methods, processes and systems.

In certain embodiments, a gel herein contains not only a layer of PDA, but also sodium alginate (SA). In certain embodiments, the sodium alginate solution includes a metal capable of coordinating with catechol groups of the polydopamine, for example, copper (e.g., Cu²⁺).

In certain embodiments, the sodium alginate (SA) is superhydrophilic—that is, it has a contact angle of water of zero degrees within 30 seconds, and a water droplet can quickly diffuse into the sodium alginate (SA) film. This can further contribute to the efficacy of the compositions discussed herein. In certain embodiments, a gel composition herein has an SA layer “coating” the microporous gel skeleton; however, the terms, “layer” and “coating” do not require that the entire surface of the microporous gel skeleton be completely covered by a unifolln or unbroken amount of any substance (including, for example, SA), only that a portion of its surface is at least partially adhered to with the other substance.

It has been found that upon immersion into contaminated water, the SAG can absorb large quantities of water, while contaminants (including salts, biologics, oils and other pollutants) can be expelled. Further, once exposed to natural or artificial sunlight, solar absorption by the PDA can thermally heat the SAG above the LCST of PNIPAm. Due to the hydrogel phase transformation from the “swollen” hydrophilic state to the “collapsed” hydrophobic state at the LCST, clean water (in the form of liquid water, or combined liquid water and water vapor), can then be expelled from the SAG.

In certain embodiments, when contaminated water enters a gel, and then is expelled as less-contaminated (or “pure” or “purified” water), the concentration of contaminants in the less-contaminated water is less than 5%, or less than 2%, or less than 1% of the concentration of contaminants originally present in the contaminated water.

In certain embodiments, this process can be repeated as many times as necessary, as the water increases in purity and decreases in contamination, until the desired level of purity is achieved. That is, the system can use the expelled less-contaminated water as the source of contaminated water in a subsequent repetition of the steps, in a manner that provides water of increased purity over a previous repetition of the steps.

In certain embodiments, the SAG technology herein works well because it can integrate the desired optical, thermal, elastic and wetting properties into a single materials platform for solar-driven water purification; that is: (i) PNIPAm can function as the flexible water collection vessel, as well as a transport medium; (ii) PDA can function as the broad spectrum light-to-thermal conversion material, as well as a pollutant filter; and (iii) SA can function as the hydrophilic thermal insulator, as well as a pollutant filter.

Moreover, an advantage of the methods and processes herein is the ability to generate liquid water without the need for either a steam generation step or a condensation step. That is, in certain embodiments, a method or process herein can be accomplished completely, or substantially completely, by solar power, without the need for any other power input.

The aqueous-based fabrication process of SAG in certain embodiments is shown in FIG. 4A. As can be seen there, traditional PNIPAm gel cross-linked with N,N′-methylene bisacrylamide (BIS) is brittle and not generally suitable for multi-cycle usage herein. Instead, the SAG developed herein, in certain embodiments, uses PNIPAm microgels as the crosslinker to improve elasticity and mechanical stability.

Further details of the fabrication processes and methods herein are set forth in Example 1.

### Solar Power

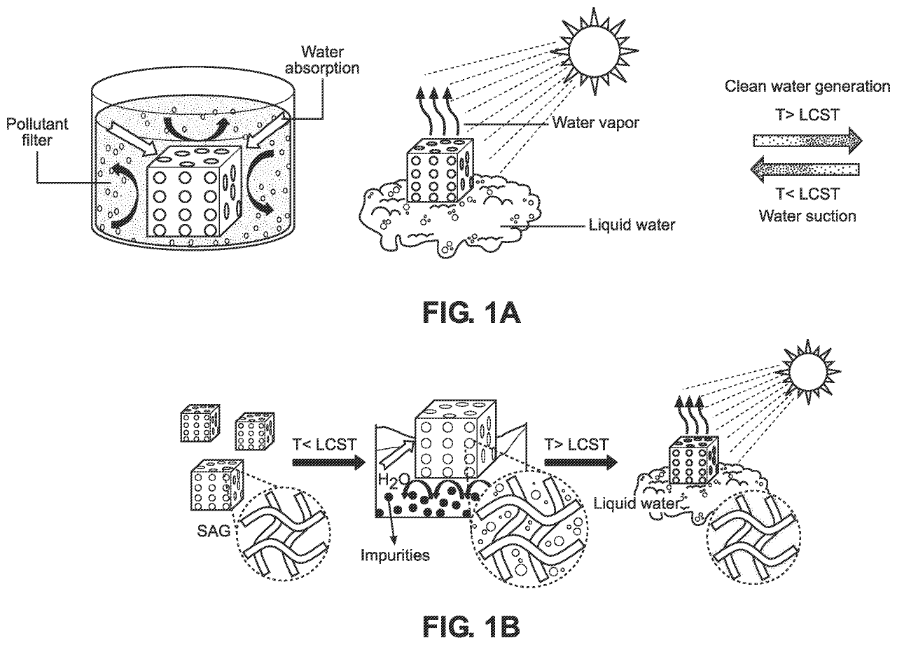

In certain embodiments, the methods and processes herein can be solely powered by light, including natural or artificial light; for example, by natural sunlight as shown in FIG. 1B.

In certain embodiments, an approach herein can be employed for, inter alia, high-rate clean water purification and production from a polluted water source by taking full use of renewable solar energy. Considering the high photothermal conversion efficiency, thermal responsive property, the methods and systems herein can have great potential applications not only in diverse water treatments but also in other potential photothermal catalysis, drug release, and desalination applications.

As sunlight driven purifiers, in certain embodiments the 3D solar absorber gels discussed herein can exhibit several advantages. Among these are:

(1) The fabrication progress is facile, green, time-saving, and cost-efficient because, among other reasons, the gel can be prepared at room temperature using water as medium without any toxic solvents or complicated equipment.

(2) The gels discussed herein can exhibit high purification performance, as in certain embodiments, the outer sodium alginate (SA) layer can filter off the natural particulates, including dust, sand, or bacteria in fresh water. After being immersed in pollute water, in certain embodiments a gel herein can absorb a large amount of clean water, as the pollutants are repelled by the SA layer (see, e.g., FIG. 1, which shows an exemplary water purification procedure based on a 3D solar absorber gel under 1 sun irradiation). This attribute offers the possibilities of pollutants' filtering and antifouling capabilities especially useful when performing solar-driven water production using turbid/polluted water source.

(3) The water collection rate of the 3D solar absorber gel is much higher than any other conventional sunlight evaporation devices known in the art. As established in the Examples herein, in various embodiments the methods, processes and systems herein are capable of achieving a water purification rate of at least 5 kg m⁻²h⁻¹ (that is, 5 kg per meters squared hour, alternatively expressed herein as kg/m² hour), at least 6 kg m⁻²h⁻¹ or at least 7 kg m⁻²h⁻¹. These superior water collection rates can be due to the integration of excellent sunlight-to-thermal conversion of PDA and the thermal-responsive hydrophilicity switching feature of PNIPAm. On exposure to sunlight, PDA converts light to thermal energy through photothermal effects. When the temperature was increased above the LCST, the hybrid PNIPAm-PDA-SA hydrogels of the present technology undergo a phase transition from a hydrophilic “swollen” state to a hydrophobic “collapsed” state, leading to a significant volume change. Thus, in the shrinking process, clean water can be produced not only from the solar evaporation, but also via the squeezed-out water by a serious volume shrinking of swollen gel (see, e.g., FIG. 1).

Thus, as demonstrated herein, the methods and processes herein can work by immersing into contaminated water, wherein it absorbs pure (or substantially pure) water while repelling harmful impurities. Subsequently, purified water can be expelled from the SAG when irradiated under sunlight (e.g., irradiated under one sun or exposed to natural sunlight). While, in certain embodiments, capillary action drives water transport in the SAG, the SA layer's filter efficiency can also significantly diminish the possibility of fouling.

In various embodiments, the methods and processes herein can work effectively with substantially no water evaporation or condensation; or can include some water evaporation or condensation, in conjunction with the hydrogel phase change mechanisms discussed herein.

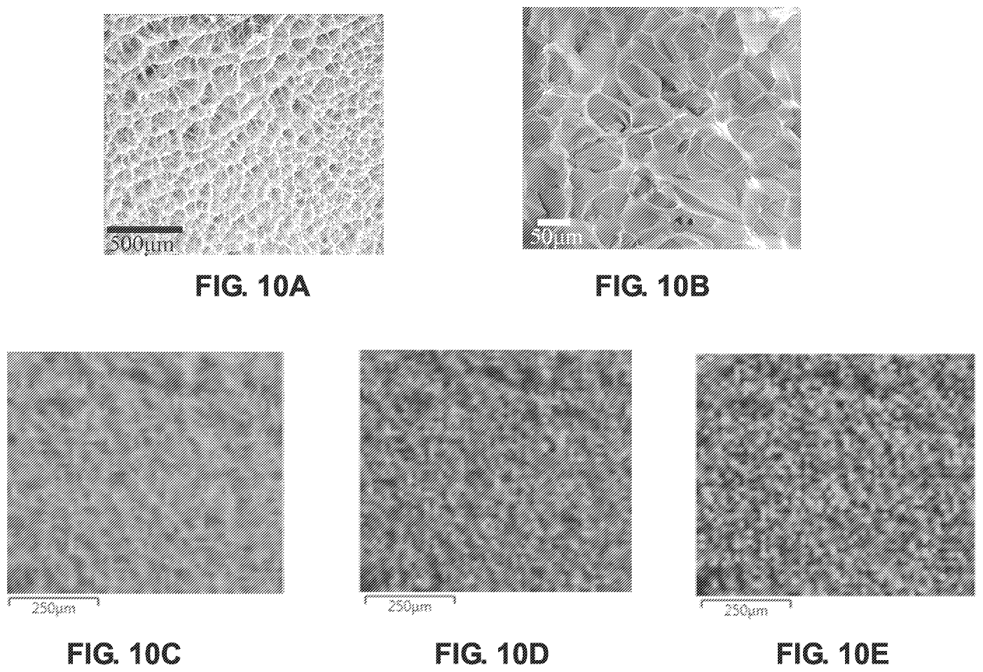

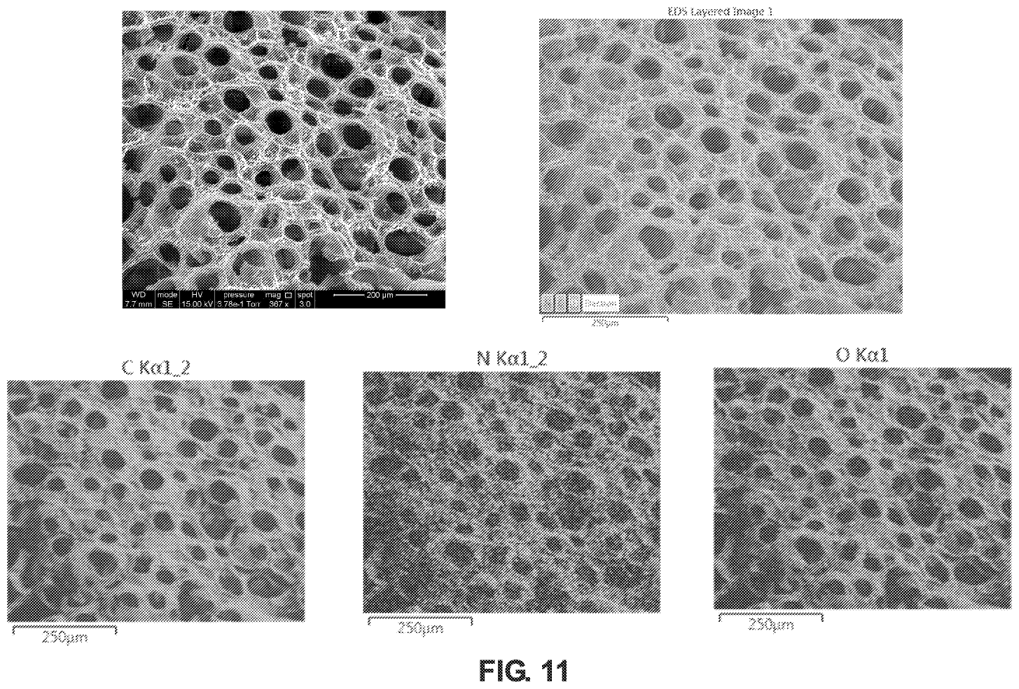

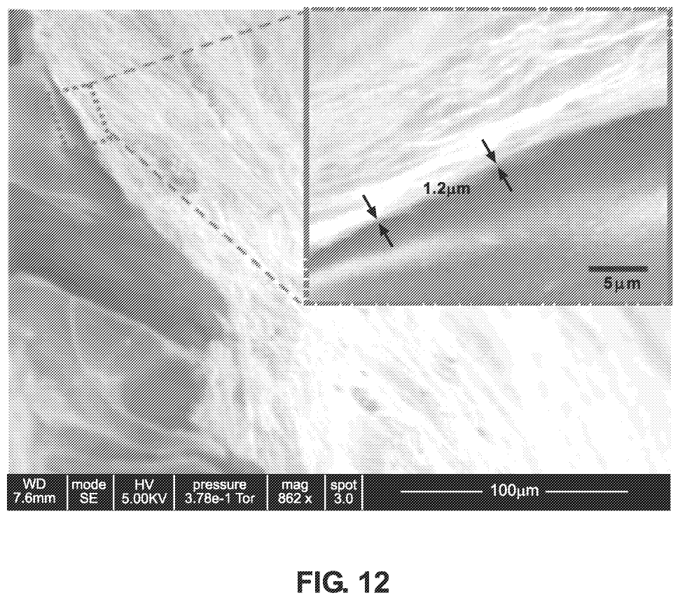

In certain embodiments, the structure of the gels herein can be generally honeycomb-like. See, for example, FIGS. 2 and 4. As shown through SEM, in certain embodiments a SAG herein shows high porosity (see, e.g., FIG. 10). This can provide a good structure for water transport via capillary flow. Following coating with the PDA, in certain embodiments the gel can preserve the interconnected porous structure, with an average pore size of 20 to 100 μm, 30 to 90 μm, 40 to 80 μm, 40 to 75 μm, 40 to 60 μm or 50 5o 55 μm (see, e.g., FIGS. 4B-C).

In certain embodiments, a 3D solar absorber gel herein can be prepared through a convenient dip-coating method at or around room temperature, as will be illustrated in detail in the Examples below.

For at least the reasons discussed herein, the 3D porous hydrogels of the present technology can be, in certain embodiments, not only favorable for water and steam flow, but also useful for rejecting particulates, dirt, bacteria and naturally occurring organic matter in water.

In certain embodiments, the 3D hydrogels of the present technology can be easily prepared at or around room temperature, for example, by immersing supporting gel into dopamine solution and sodium alginate solution, respectively. As used herein, “room temperature” means in the range of 20 to 25° C. (68 to 77° F., or 293 to 298 K). Such a fabrication process is facile and convenient without the need for any complicated and advanced equipment. Moreover, all the ingredients are low-cost, non-toxic, and green materials that dissolve in an aqueous solution without any expensive solvent, and there is no secondary pollution generated during the process. Besides that, the disclosed 3D porous gels herein can exhibit fast production of high-quality clean water under 1 sun irradiation, which favors the practical applications for water harvesting from diverse wastewater.

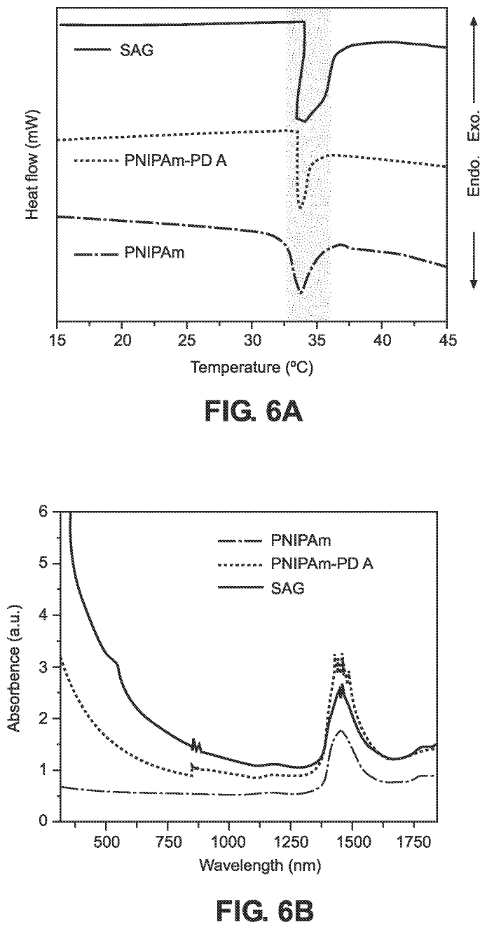

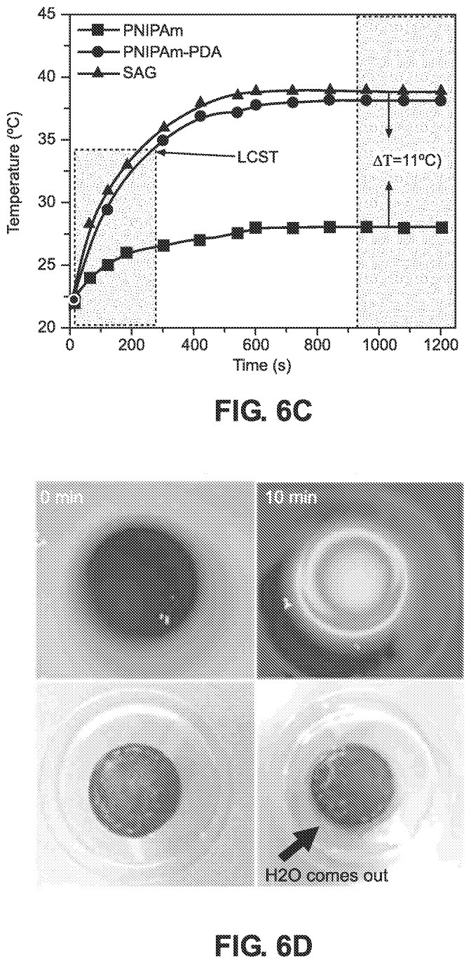

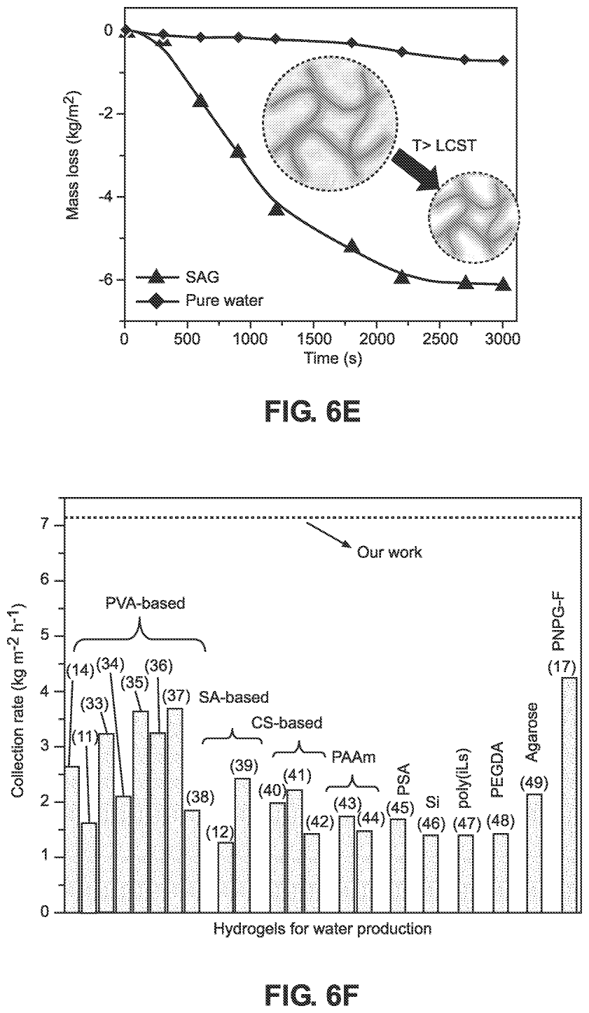

For example, FIG. 6F has comparative data showing the collection rates in kg/m² hour, clearly indicating that the hydrogels herein exhibit far superior rates than those of known materials.

Moreover, in certain embodiments the present technology is directed to methods of purifying water, as well as systems configured to provide purified water from contaminated water. In certain embodiments, a system herein is configured wherein the hydrophilic 3D microporous gel, when immersed into contaminated water, absorbs water while repelling one or more of the contaminants in the water, resulting in a gel in a hydrophilic swollen state containing purified water. Thereafter, the gel in a swollen state, when exposed to sunlight, can transition to a hydrophobic state, thereby expelling the purified water.

In various embodiments, a system herein can further comprise one or more of the following: (a) a porous plate configured to contact the hydrophilic 3D microporous gel before and during its hydrophilic swollen state; or (b) a receptacle configured to catch the purified water when it is expelled from the 3D gel. For example, as will be illustrated later herein, in certain embodiments a system herein can comprise a water purification system that includes a piece of a gel as described herein, held within a porous plate, and allowed to float within a contaminated body of water such as a lake, river or container, and allowed to swell as the contaminated water absorbs into the gel. Thereafter, the gel can be removed from the water, allowed to absorb sunlight for a period of time (for example, up to 2 hours, up to 4 hours, up to 12 hours or up to 18 hours) such that the phase change occurs, and purified water exits the gel. In certain embodiments, a system herein includes a receptacle to catch the purified water as it exits the gel—that is, as it is expelled from the gel composition.

Turning to the embodiments herein in more detail, further discussion is set forth in the following Examples:

### EXAMPLE 1

### Formation of SAG

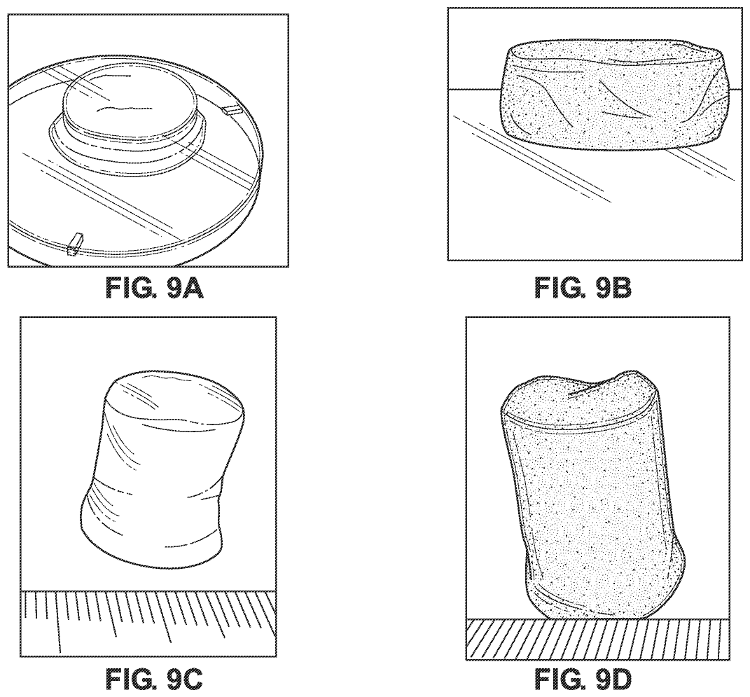

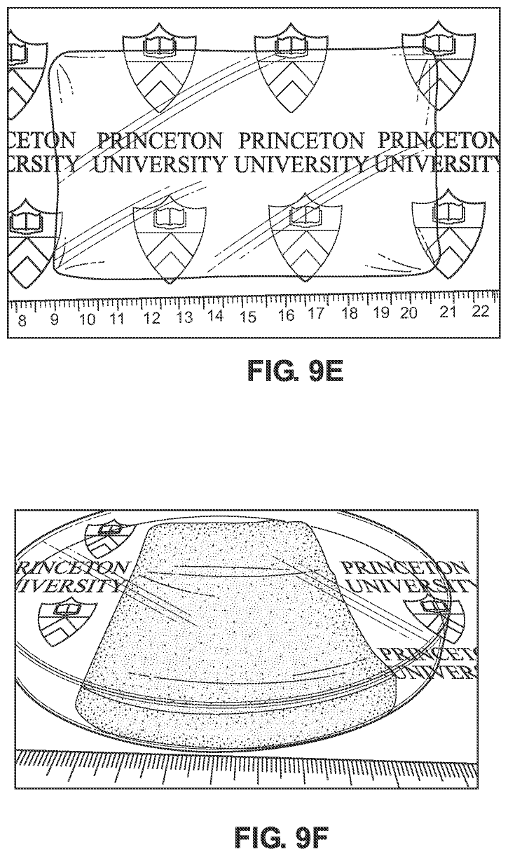

SAG according to an embodiment herein was synthesized by polymerization of N-isopropylacrylamide monomer aqueous solution. The PNIPAm hydrogel was immersed into a dopamine tris-buffer solution (2 mg/mL) at room temperature for incorporating PDA nanoparticles onto the surface of gel skeleton while retaining the 3D porous structure (as shown in FIG. 2A and FIG. 4A). A thin PDA layer was formed atop the surface of the gel skeleton. During this functionalization process, the color of hydrogel changed into dark color (black or almost black), confirming the successful coating and the firm deposition of a cross- linked polydopamine homopolymer (see the contrast in FIGS. 9A-F). PDA possesses uniformly distributed catechol groups, which can be easily oxide and coordinated with metal cations spontaneously to form stable coordination bond. For the last step of SA membrane coating, the PDA-modified gel was then immersed into a CuCl₂ solution and a sodium alginate solution for 5 minutes. The cross-linked SA was adsorbed atop the PDA layer via coordination bonding between the one or more catechol groups of the PDA and Cu²⁺.

The structure of the disclosed 3D porous gel was examined using SEM. Results are shown in FIGS. 2 and 4. As revealed by SEM, the PNIPAm gel had a honeycomb-like structure with high porosity, providing a good platform for water transport via capillary flow. Following coating with the PDA, the hybrid gel preserved the interconnected porous structure, with an average por size of 50 μm (see FIGS. 4B-C). As shown, for example in FIG. 2B, the PDA nanoparticles adhered firmly to the hydrogel skeleton due to its catechol group, while preserving the overall microporous structure as water transport channels and steam pathways. Higher magnification revealed that PDA was indeed deposited atop the PNIPAm structure in the form of nanoparticles.

Energy-dispersive X-ray (EDX) elemental mappings showed the existence of C K-edge, N K-edge, and O K-edge elements on PDA modified PNIPAm gel. The SA coating led to a high density and homogeneous polymer film atop the hydrogel surface. For example, (FIG. 2C) shows both Cu and Na signals were uniformly distributed throughout the scanning area, and large pores on the hydrogel surface were not observed. No N element of PDA and PNIPAm was detected, further confirming the successful and well-controlled deposition of Cu²⁺/alginate layer on the surfaces of whole hydrogel. As another example, FIG. 4D also shows EDX elemental mappings for Cu L-edge, C K-edge, Na K-edge, and O K-edge elements. Noticeably, both Cu and Na signals were uniformly distributed throughout the scanning area, and no N elements of PDA or PNIPAm were detected, further confirming the successful and well-controlled deposition of SA, with thickness of 1.2 μm atop the surface of the hybrid hydrogel.

Results further showed that, while traditional PNIPAm gel crosslinked by N,N′-methylenebisacrylamide (BIS) could not be elastic at all, and even broke into pieces under compression, the PNIPAm gel obtained using microgels as crosslinkers as formed herein was found to be extremely elastic, and could be compressed and recovered to its original shape. Moreover, the SAG formed herein could maintain the elastic properties of PNIPAm after modified with PDA and SA. The gels formed herein were found to be recoverable to their original state after stretching to several times their original length.

### EXAMPLE 2

### Compression Testing, Wetting Behavior and XPS of SAG

Standard compression tests were conducted to demonstrate the elasticity of the SAG formed in accordance with embodiments herein.

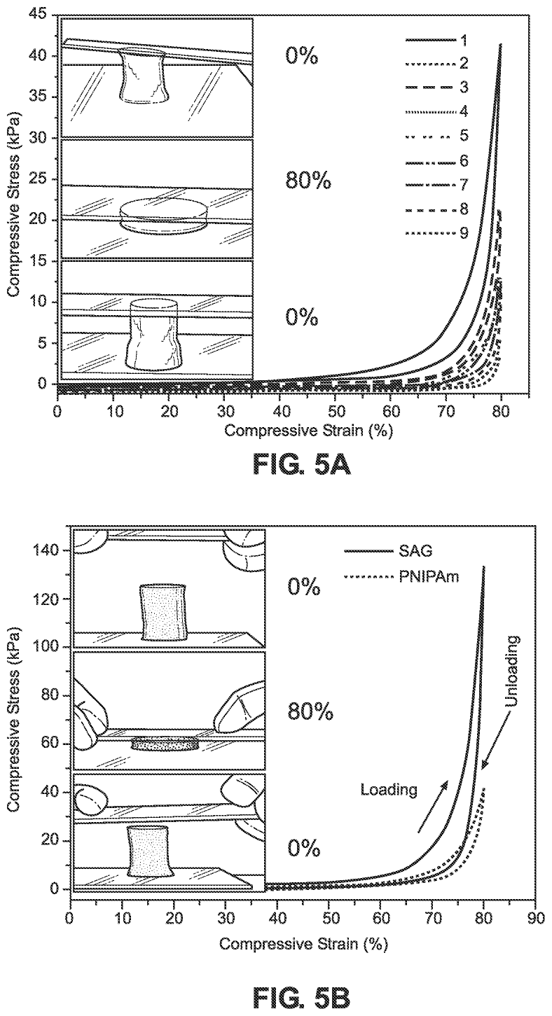

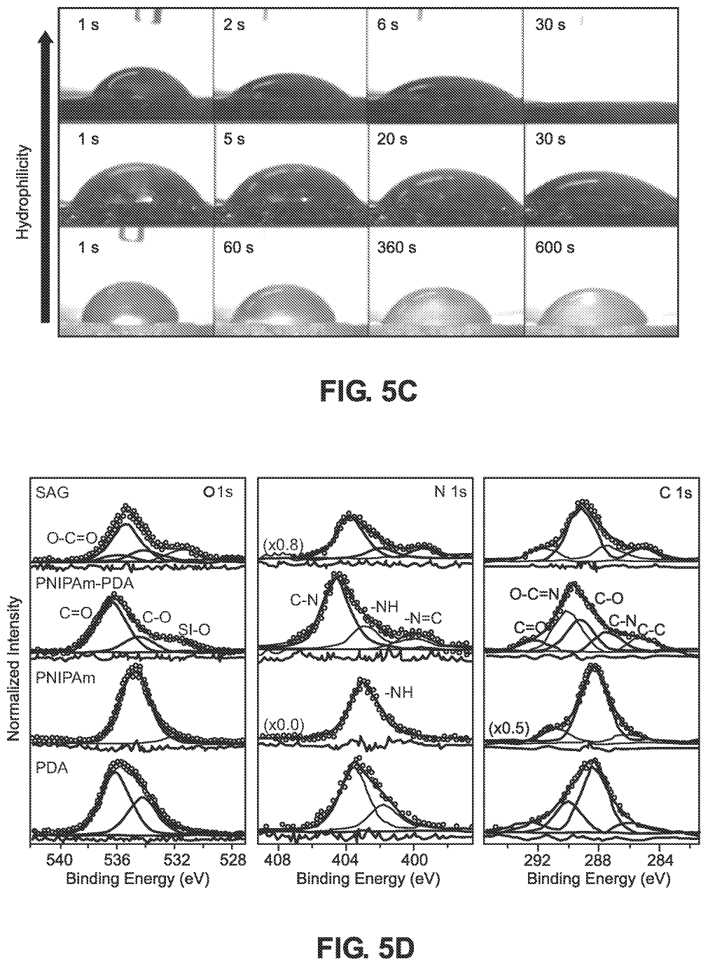

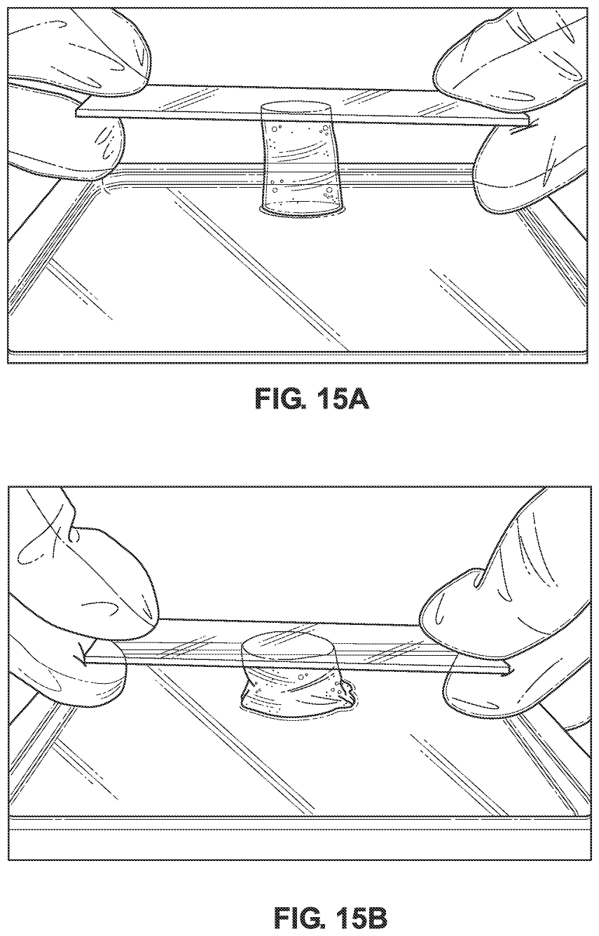

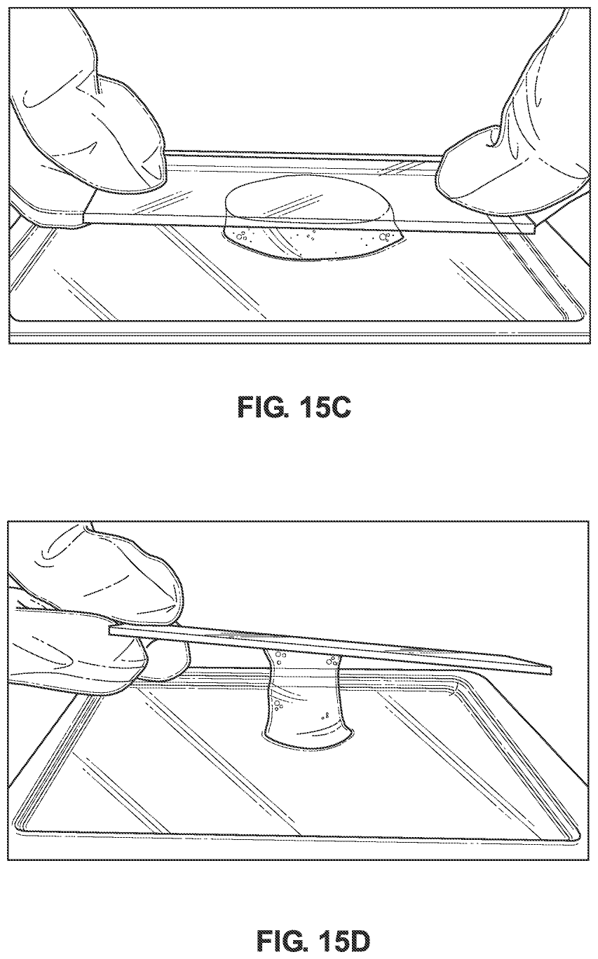

As expected, the traditional, BIS-cross-linked PNIPAm gel was brittle and could not sustain compression. In contrast, the microgel-crosslinked PNIPAm gels prepared exhibited greater deformation under stress and complete recovery upon removal of the stress (see, e.g., FIGS. 15A-D). After nine loading-unloading cycles at ˜80% strain, the modified PNIPAm gel maintained good technical stability (FIG. 5A), an advantage of the cross-linked microgel nanostructure.

After functionalization with PDA and SA, the gel remained elastic. As shown in FIG. 5A, the compressive stress-strain curve of the SAG demonstrated that the recoverable compressive strain could reach, in various embodiments, at least 50%, at least 60%, at least 70% or at least 80%. It was also observed that the strain gradually reduced to zero as the stress was removed. Of note, the SAG rapidly recovered to its original shape after high compression or extensive stretching (see, e.g., FIG. 15D)

The influence of PDA and SA on the wetting properties of the PNIPAm gel was investigated by recording the dynamic wetting behavior of a water droplet at room temperature. As shown in FIG. 5C, when placed atop PNIPAm, the water droplet remained stable with a water contact angle of about 53 degrees. In contrast, for the PDA-modified PNIPAm, the water contact angle decreased to about 20 degrees within 30 seconds, due to polydopamine's hydrophilicity. Finally, the water droplet quickly imbibed into SAG, due to the combined SA and PDA layers, within 30 seconds. This indicated that the SAG was hydrophilic, which is useful to facilitate water transport within the membrane and to reject hydrophobic contaminants, such as oil.

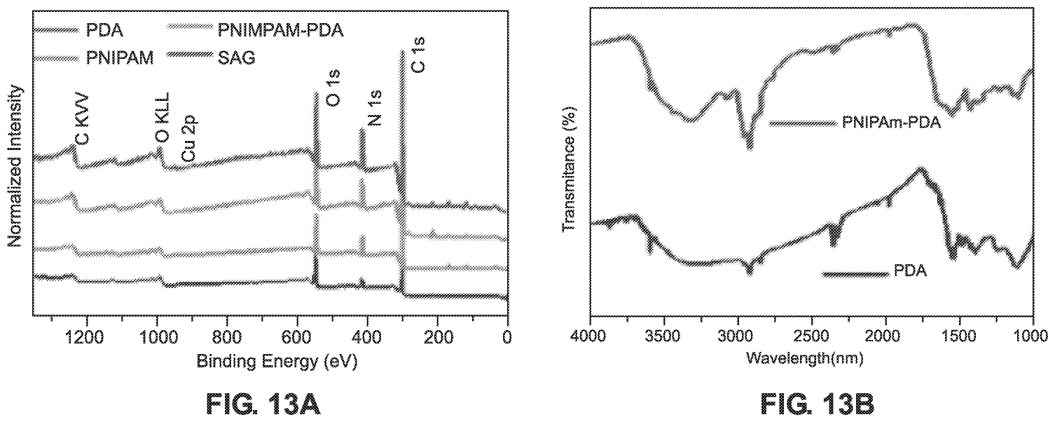

X-ray photoelectron Spectroscopy (XPS) was also performed on the gels herein, with Fourier transform infrared spectroscopy (FTIR) to confirm the chemical composition of the SAG. From XPS of the SAG (FIG. 13), the peaks located at 530, 400 and 285 eV were assigned to oxygen (O), nitrogen (N) and carbon (C). The peak appeared around 950 eV, corresponding to the binding energy of Cu²⁺. Each element's high-resolution spectra provided further evidence for the successful modification of PNIPAm by PDA and SA (see, e.g., FIG. 5D). From the FTIR spectra of FIG. 13B, a broadband at about 3400 cm⁻¹ could be attributed to the N—H stretching vibration of the PNIPAm and the O—H stretching vibration of the hydroxyl groups on PDA. The peaks at 1643 cm⁻¹ and 1551 cm⁻¹ represent the typical C═O stretching and N—H stretching of PNIPAm, respectively. Taken together, these results strongly indicated the formation of SAG, in good agreement with SEM characterizations.

Another merit of the SAG observed was the rapid water release triggered by the phase transformation of PNIPAm at its LCST. The LCST was confirmed by differential scanning calorimetry (DSC), with results shown in FIG. 6A. The LCST of PNIPAm was identified by the endothermic peak at about 34° C., and was unaffected by the treatment with PDA and SA. The low-temperature LCST of the SAG is beneficial for driving water purification under conditions involving natural sunlight. Another useful requirement for solar-driven water production is broadband and efficient light absorption. The total solar absorbance of the SAG was measured via UV-vis-NIR spectroscopy in the wavelength range of 200 to 1800 nm. As shown in FIG. 6B, the SAG exhibited broad and efficient absorption.

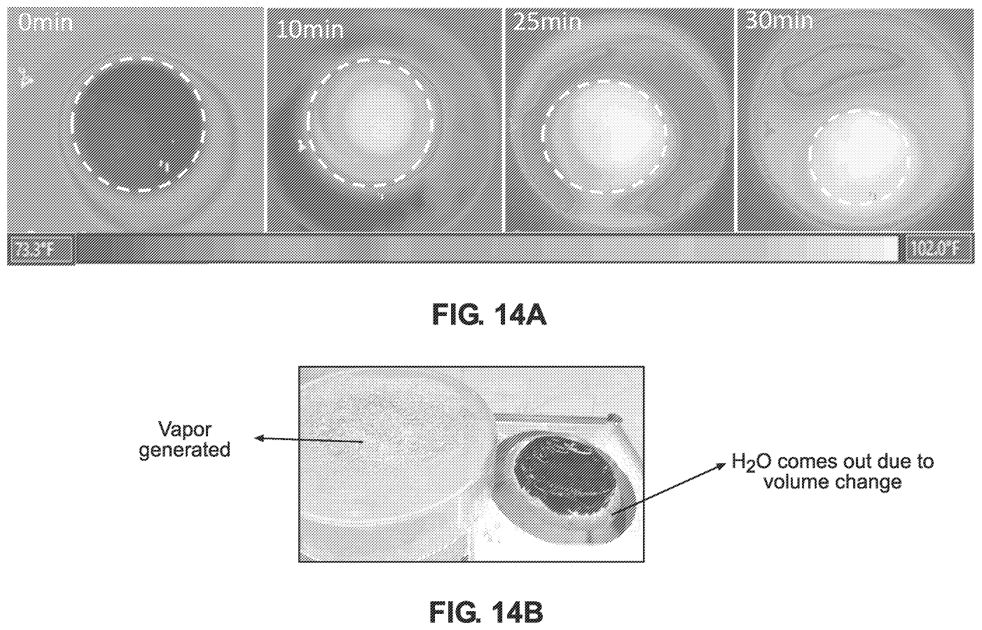

The low-temperature light-driven water release from the SAG was assessed by simulated sunlight of 1 kW/m² (1 sun). Under one sun illumination, the surface temperature of the SAG increased with time and reached its LCST within 300 seconds of illumination (as shown in FIG. 6C). The eventual surface temperature of the SAG was about 39° C., about 5° C. higher than the LCST. In contrast, irradiation raised the surface temperature of pure PNIPAm to about 28° C., well below the LCST. This comparison convincingly demonstrates the use of PDA as a photothermal conversation material. The PDA heating effect was also revealed by infrared images; see FIG. 14. The substantially homogeneous distribution of hot areas again confirmed that PDA was substantially uniformly distributed atop the PNIPAm.

### EXAMPLE 3

### Water Release Rate

To test the water-swollen SAG water release rate, it was exposed to simulated sunlight. At the LCST, the hydrophilicity of PNIPAm is switched via a conformational change. In response, it was expected that any stored liquid would be expelled. As shown in FIG. 6D, exposure of a SAG formed herein to simulated sunlight was seen to drive liquid water release. Also, minimal water vapor was collected by the evaporation-condensation process (see, e.g., FIG. 14). Therefore, it was concluded that the SAG combines two water releasing modes into a single material platform. The SAG technology represents a clean water production mechanism unique beyond previously reported solar-driven water collection systems that are based solely on steam/vapor generation. In this regard, the materials, methods and processes herein can overcome two major drawbacks of known systems: (1) low water collection rate; and (2) high energy requirement for evaporation.

As shown in FIG. 6E, when water-swollen SAG was irradiated by one sun, the mass loss increased with time, and the weight change was 80 to 90%, or about 87.4% after 30 minutes. This indicates that nearly all of the absorbed water within the SAG was released. In comparison, pure water exhibited a negligible mass loss under the same conditions. More remarkably, the SAG's water collection rate reached over 7 kg^{m-2}h⁻² under one sun irradiation (about 7.18 kg^{m-2}h⁻², see FIG. 4F). Since the purification mechanism in certain embodiments herein does not include water evaporation at all, or includes substantially no water evaporation (which is an energy-intensive process), the water collection rates found using the present technology can be higher than that of those that do rely on evaporation: poly(vinyl alcohol) (PVA), alginate (SA), chitosan (CS), polyacrylamide (PAAm), poly(sodium acrylate) (PSA), silica gel, poly(ionic liquid)s (PILs), poly(ethylene glycol) diacrylate (PEGDA) and agarose (see, e.g., FIG. 6F with comparisons). The high water collection rate of the technology herein is likely due at least in part to the thermoresponsive phase transformation of the PNIPAm, which boosts the liquid water release at the LCST.

### EXAMPLE 4

### Decontamination Capability

A sensible route to improving access to clean water is to obtain it from various contaminated sources after purification. The water decontamination capability of the present materials was tested in multiple model wastewater feedstocks containing small molecule dyes, heavy metals, oil, and yeast.

First, three (3) organic dyes (Rhodamine 6G (R6G), methyl orange (MO) and 4-nitrophenol (4-Nip)) with different sizes and surface charges and lead (Pb) were selected as representative model contaminants to test the solar-driven water of an SAG herein. R6G is positively charged, MO is negatively charged, and 4-Nip is an essentially neutral compound.

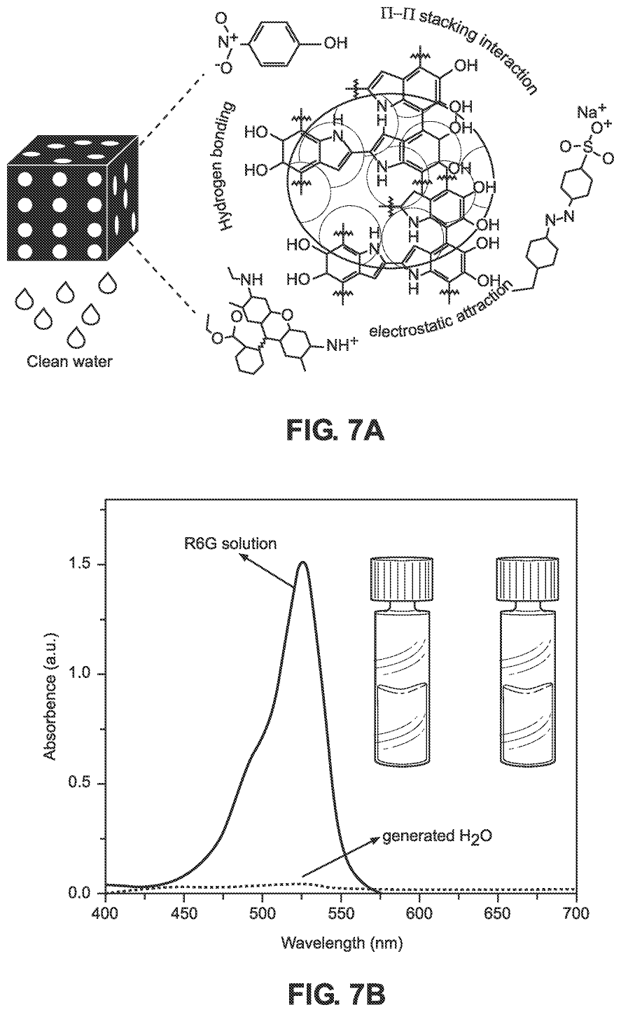

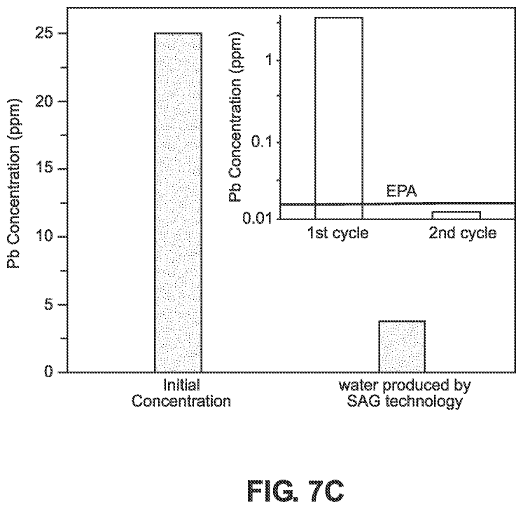

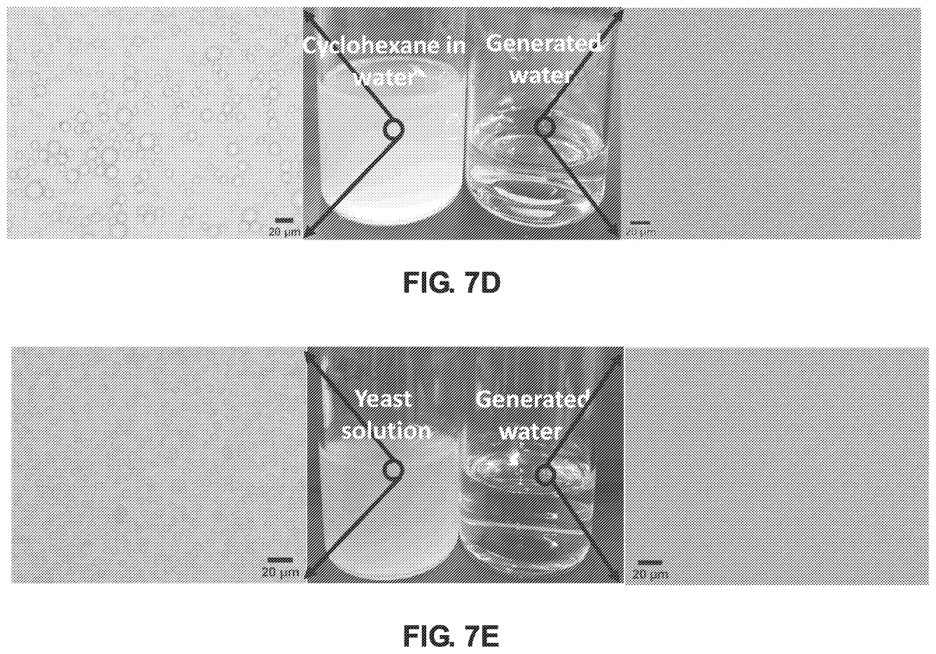

For the R6G, the SAG rejected over 95% (about 97.1%) and produced water with high purity, as evident by color change, after one treatment cycle (see FIG. 7B).

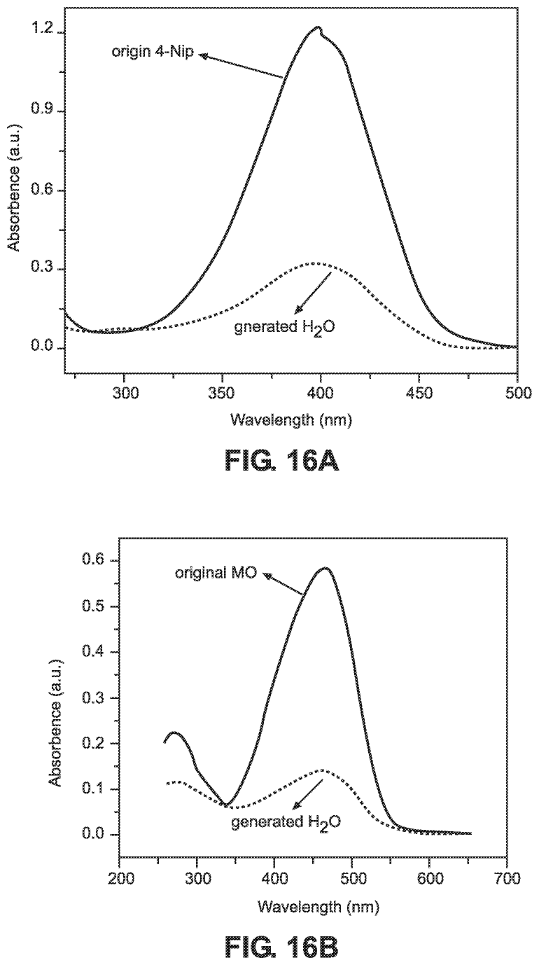

The SAG rejection rate of MO and 4-Nip samples was over 85% (about 87.7%) and over 80% (about 84%), respectively, after one treatment cycle (see FIG. 16).

The high density of amine and catechol groups of PDA can strongly scavenge metals. As shown in FIG. 7C, after one treatment by an SAG herein, the concentration of Pb²⁺ ions in contaminated water decreased from about 25 to under 5 ppm (about 3.7 ppm), showing its efficacy at decontaminating water containing heavy metals. In a second cycle, the SAG was observed to reduce the Pb²⁺ concentrations from about 3.7 ppm down to below the U.S. Environmental Protection Agency (EPA) allowable limits for drinking water (15 ppm). In fact, in certain embodiments the reduction was quite dramatic—below 15 ppm, below 10 ppm, below 5 ppm and below 1 ppm, below 0.5 ppm (and even as low as about 0.012 ppm). These impressive results are likely due to the introduction of the PDA and SA into the porous gel network.

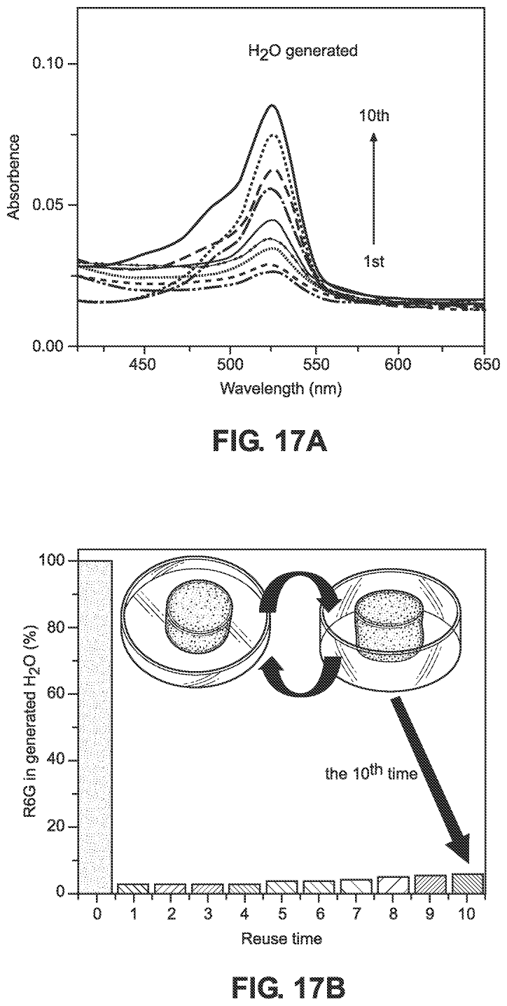

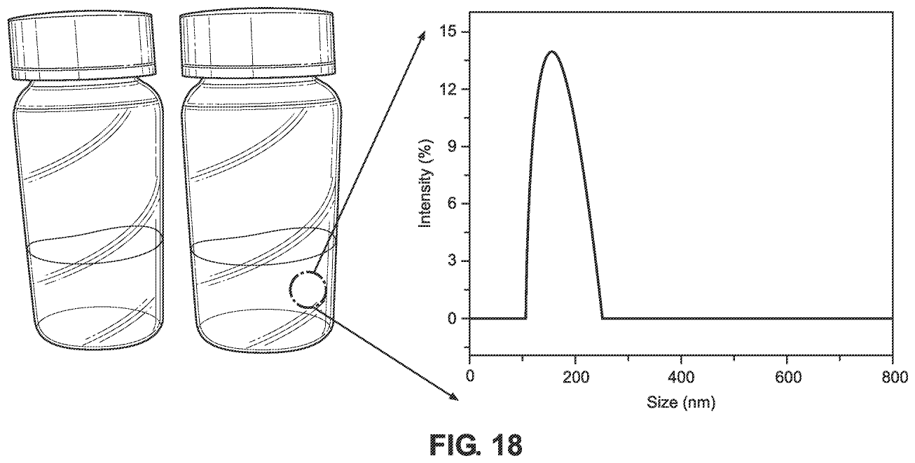

Another criterion for assessing the practicality of wastewater purification material is its reusability. As shown in FIG. 17, the SAG showed little deterioration of water purification after 10 cycles. This can be attributed to the SAG structure and adhesion between the different layers (see FIG. 18).

Additionally of practical importance is the purification of water from emulsified oil/water mixtures during cleanup and environmental remediation. The water purification property and recyclability of the 3D porous gel were further tested as follows: To validate the application of sunlight driven purifier in wastewater purification, the 3D porous hydrogel was soaked in various simulated wastewater including organic dye-, oil-, and bacteria-contaminated wastewater.

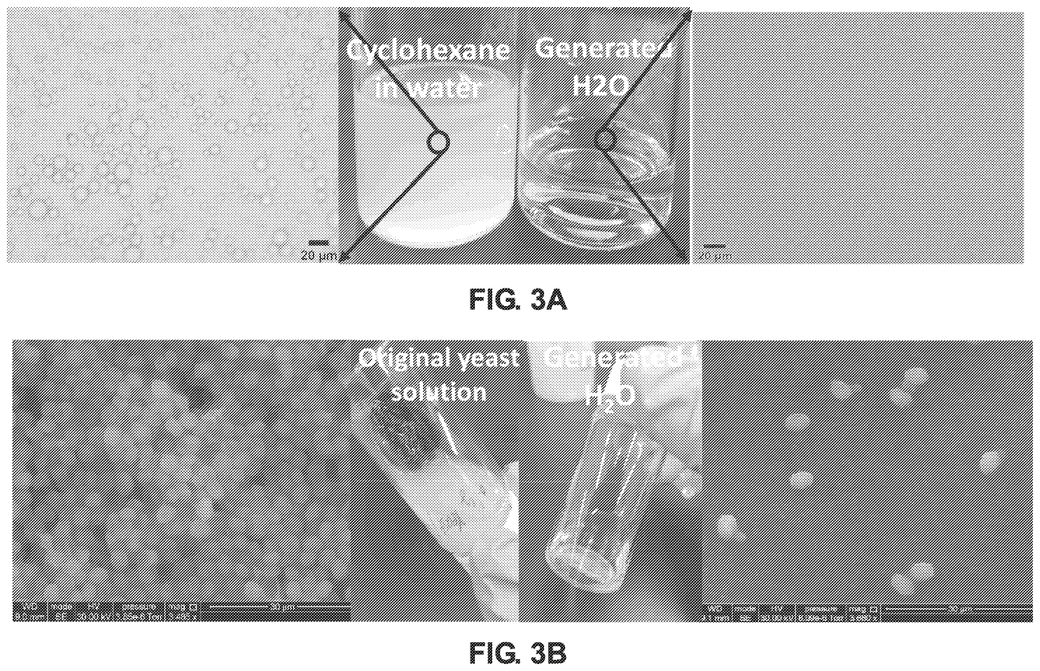

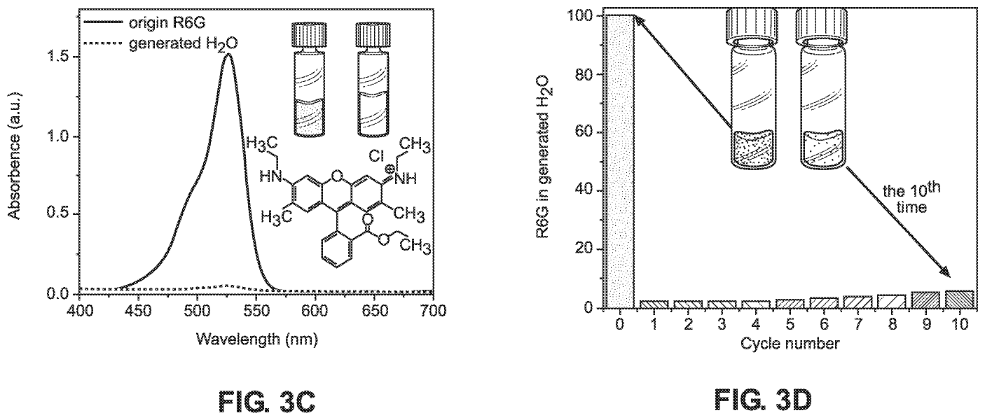

First, sodium dodecyl sulfonate (SDS) stabilized oil-in-water emulsions composed of cyclohexane were used as models to evaluate the purification ability of the hybrid gel. The original SDS-stabilized emulsions are milky white. After separation by the 3D gel, the produced water from gel under sunlight irradiation became totally transparent and clear (see FIG. 3A). Correspondingly, in the collected water, no oil droplets are observed in the optical microscopy images, indicating that almost all oil droplets were rejected by hydrogel.

Given that approximately 80% of known diseases are spread because of drinking unsafe water related to bacteria, in this work, the bacteria rejection property of the dry hybrid hydrogel was tested by using 1 wt % yeast solution. As shown in FIGS. 3B and 7E, because of a very high yeast concentration, the yeast cells aggregated to form a thick layer. For the generated water sample from gel, almost all of the yeasts were blocked off and only a few yeast cells were dispersed randomly, indicating the likely production of clean water excluding bacteria. Thus, in certain embodiments, the SAG herein was found to produce substantially clean water with substantially no yeast cells.

As shown in FIG. 3C, the gel also exhibited strong purification performance for R6G contaminated water, and was found to produce high purity water. After 10 cycles of water production, only 5.8% of R6G existed in the generated water (see FIG. 3D). The 3D porous gel was also shown to be mechanically stable for reusability and recycling, without obvious deterioration of water purification property.

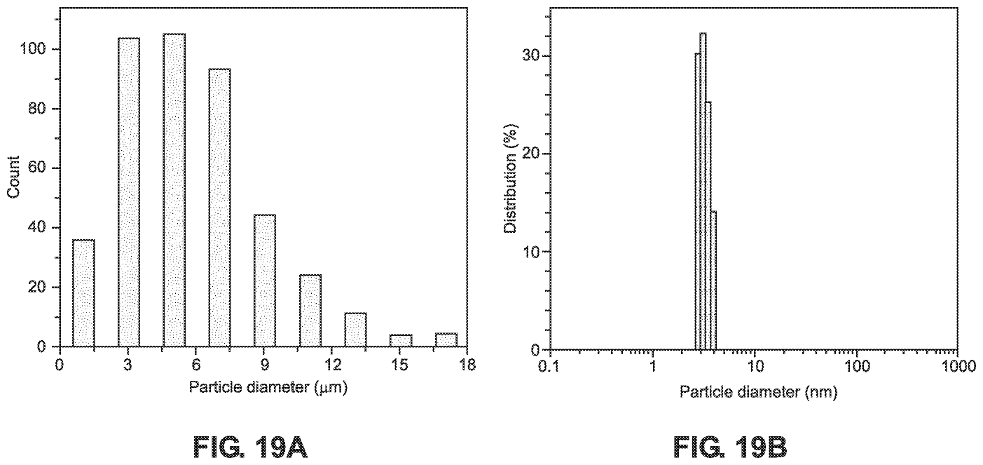

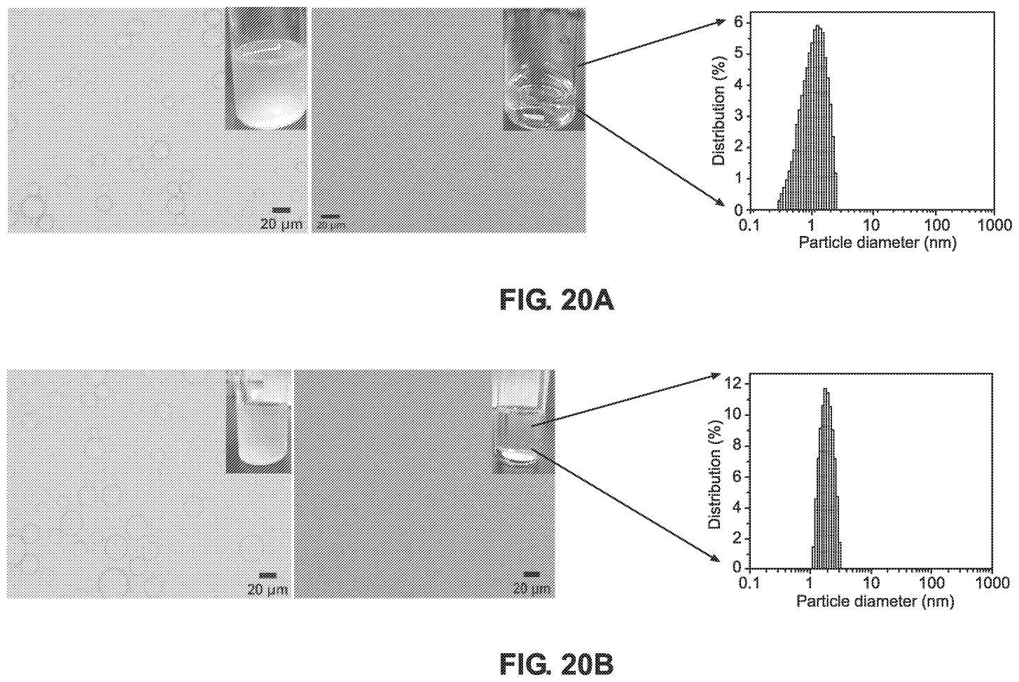

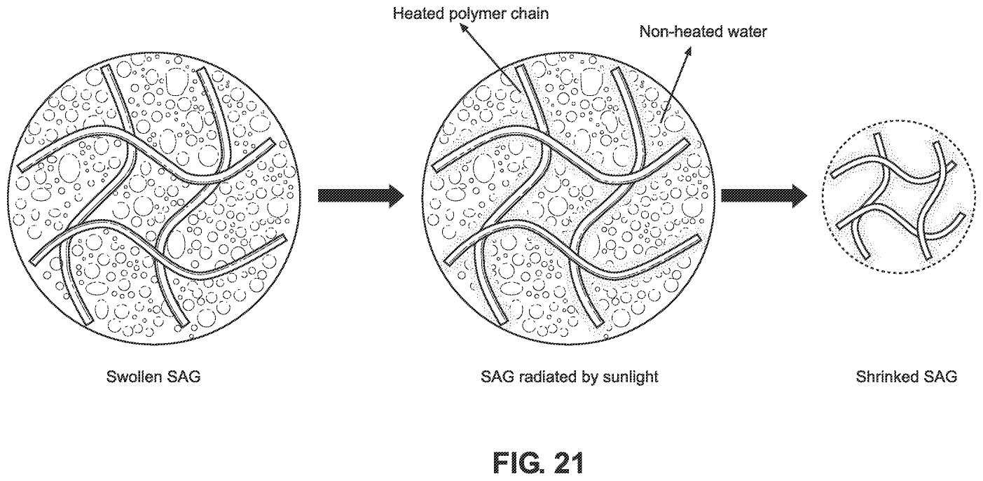

In further testing, SAG decontaminated water from three different emulsions comprising either hexane, cyclohexane, or petroleum ether was subject to experiments as set forth below. As shown in FIG. 7D, the original cyclohexane-in-water emulsion was milky white visually, and the diameter of the cyclohexane droplets in the emulsion ranged from 1 to 30 μm (see FIGS. 19A and 20A-B). After one SAG treatment, clean water was produced without evidence of oil droplets (see FIG. 7D), as confirmed by DLS measurements (see FIG. 19B).

As for the other oil-in-water emulsions tested, the SAG also generated purified water (see FIGS. 20A-B). Specifically, after adsorption and desorption by the solar absorber gels, the produced water became substantially transparent and clear, and no oil droplets were observed in the microscopic photographs (see FIG. 20A). As for an SDS-stabilized oil-in-water emulsion composed of hexane, the gel was able to filter effectively substantially all of the oil droplets from the emulsion and generate substantially clean water as well (see FIG. 20B). This anti-oil-fouling property of the SAGs herein was due to the strongly hydratable SA polymer around the gel, which formed a strong and sufficient hydrated layer protecting oil from adhering on the gel surface in the water environment.

The SAG's ability to create clean water from oil-in-water emulsions can be attributed to the superhydrophilicity of the SAG, that seemed to prevent oil uptake substantially.

### EXAMPLE 5

### Testing on Lake Water

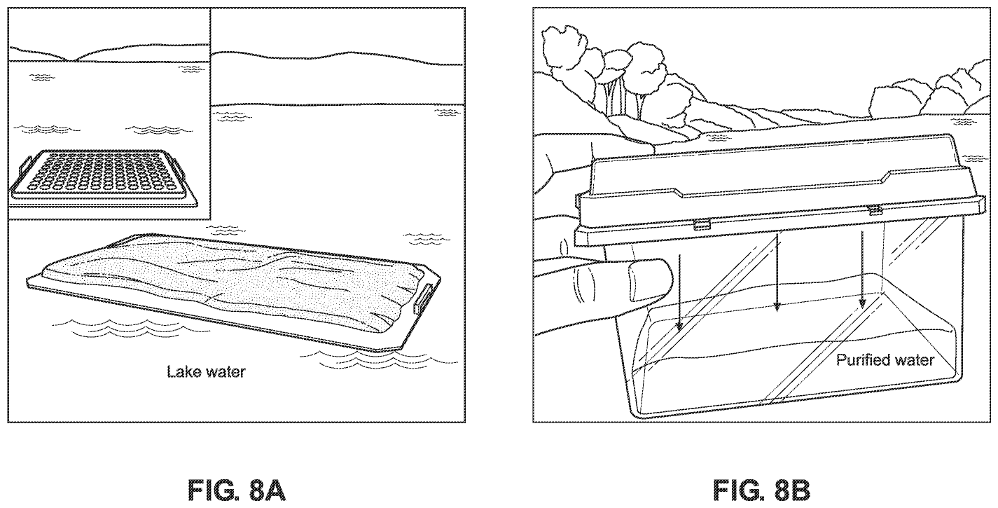

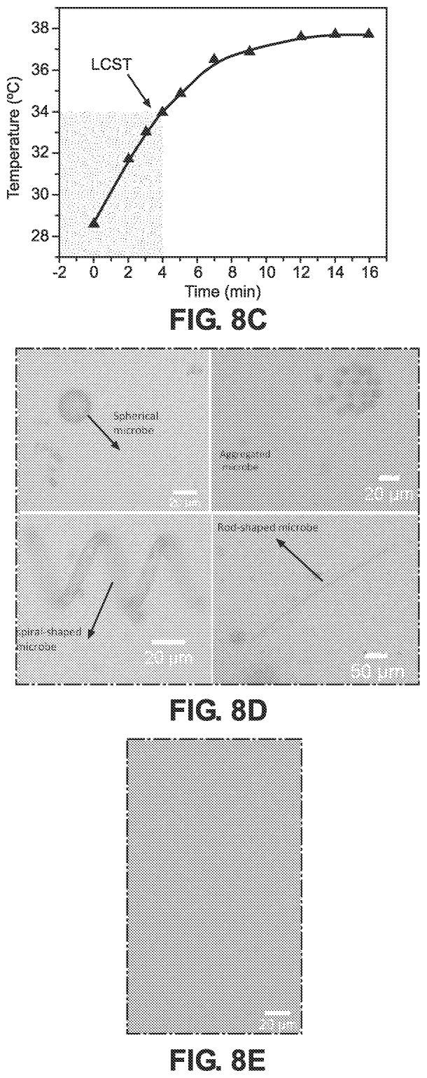

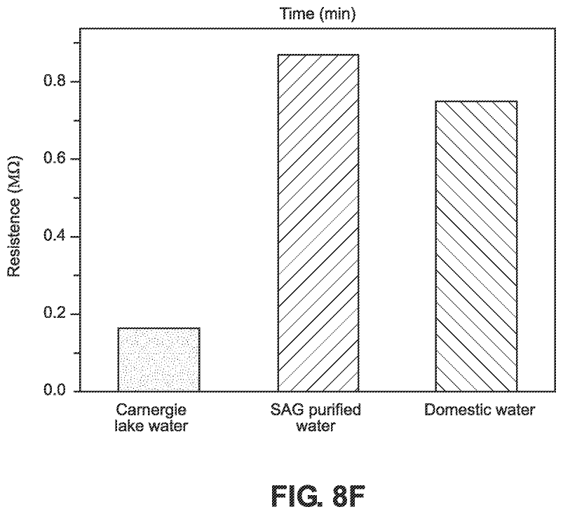

Alternative water resources, such as lake water, are a promising option to produce water safe for human consumption. A water purification system was fabricated from a material as set forth in the present technology in a cuboid structure of 11 cm×70 cm×1 cm, placed atop a porous plate and floated in Carnegie Lake (see FIG. 8A). The lake surface temperature was about 20 to 28° C., and most typically about 25° C. During the process, the SAG system absorbed water and reached a swollen state. Subsequently, the swollen material was taken out of the lake, placed atop a container and subjected to natural sunlight. As the surface temperature of the SAG increased to above 30° C. (in various embodiments over a period of 2 to 6 hours), and upwards of 38° C., the purification system was found to produce clean water continuously, flowing to the container's bottom through the porous plate (see FIG. 8B). In one embodiment, the system was subjected to sunlight for 2 hours, and 40 to 60 mL of clean water was generated. Microscopy images of the water from the lake before and after treatment by the system revealed that various microbes (including bacteria and other microbes that were spherical, rod-shaped, spiral-shaped and aggregated) were successfully removed by the system to produce potable water (see FIGS. 8D-E). The purified water quality was compared to that of domestic, municipal water by measuring the relative resistivities. Results are shown in FIG. 8F. As can be seen, the resistance values of water from the lake, SAG-purified water and domestic water were 0.16, 0.87 and 0.74 MΩ indicating sufficiently effective purification at temperatures of no more than 30 to 32° C. This was surmised to be a result of the SA in the gels herein, which exhibited outstanding cationic rejection behavior such as K⁺, Na⁺, Li⁺, Ca²⁺ and Mg²⁺. Moreover, the formation of the SA membrane around the SAG likely blocked the particulates movement channel. Some ions could likely enter the SAG, but would be adsorbed by the PDA.

Although the present invention has been described in relation to embodiments thereof, these embodiments and examples are merely exemplary and not intended to be limiting. Many other variations and modifications and other uses will become apparent to those skilled in the art. The present invention should, therefore, not be limited by the specific disclosure herein, and can be embodied in other forms not explicitly described here, without departing from the spirit thereof.

We claim:

1. A gel composition comprising:
(a) a 3D microporous gel skeleton comprising Poly(N-isopropylacrylamide) (PNIPAm), the 3D microporous gel skeleton having an outer surface;
(b) a plurality of polydopamine (PDA) nanoparticles adhered to the outer surface of the 3D microporous gel skeleton, the PDA nanoparticles comprising one or more catechol groups; and
(c) a sodium alginate (SA) layer coating the 3D microporous gel skeleton and the plurality of PDA nanoparticles.

2. The gel composition of claim 1, further comprising a metal configured to coordinate with the one or more catechol groups of the PDA.

3. The gel composition of claim 2, wherein the metal is copper.

4. The gel composition of claim 1, comprising:
(a) a 3D microporous gel skeleton comprising Poly(N-isopropylacrylamide) (PNIPAm), the 3D microporous gel skeleton having an outer surface;
(b) a plurality of polydopamine (PDA) nanoparticles adhered to the outer surface of the 3D microporous gel skeleton, the PDA nanoparticles comprising one or more catechol groups;
(c) a metal configured to coordinate with the one or more catechol groups of the PDA; and
(d) a sodium alginate (SA) layer coating the 3D microporous gel skeleton and the plurality of PDA nanoparticles.

5. A method of producing a water purifying gel composition, comprising the steps of:
(a) providing a 3D microporous gel skeleton;
(b) immersing the 3D microporous gel skeleton into a solution comprising dopamine to obtain a 3D microporous gel skeleton with attached polydopamine (PDA); and
(c) immersing the 3D microporous gel skeleton with attached PDA into a solution comprising sodium alginate, to obtain the water purifying gel composition.

6. The method of claim 5, wherein the sodium alginate solution includes a metal capable of coordinating with catechol groups of the polydopamine.

7. A method of purifying water, the method comprising the steps of:
(a) obtaining a gel composition comprising: (i) a 3D microporous gel skeleton; (ii) a plurality of polydopamine (PDA) nanoparticles adhered to the outer surface of the gel skeleton; and (iii) an outer layer comprising sodium alginate;
(b) immersing the gel composition into an amount of contaminated water, the contaminated water comprising water and a contaminant;
(c) allowing the outer layer of the gel composition to repel at least some of the contaminant while the 3D microporous gel skeleton absorbs at least some of the remaining, less-contaminated water;
(d) removing the gel composition from the contaminated water;
(e) exposing the gel composition to sunlight such that the sunlight is converted to thermal energy, thereby raising the temperature of the gel composition to a temperature above the lower critical solution temperature of the gel composition and causing a phase transition of the gel composition from hydrophilic to hydrophobic; and
(f) allowing the less-contaminated water absorbed in the gel skeleton to be expelled from the gel composition.

8. The method of claim 7, wherein the concentration of contaminants in the less-contaminated water is less than 5% of the concentration of contaminants originally present in the contaminated water.

9. The method of claim 7, wherein the concentration of contaminants in the less-contaminated water is less than 1% of the concentration of contaminants originally present in the contaminated water.

10. The method of claim 7, further comprising repeating steps (a) through (e).

11. The method of claim 10, further comprising repeating steps (a) through (e), using the expelled less-contaminated water as the source of contaminated water in a subsequent repetition of the steps, in a manner that provides water of increased purity over a previous repetition of the steps.

12. The method of claim 7, wherein the contaminant is a hydrocarbon, a strain of bacteria, a metal, a dye, a particulate, dirt, naturally occurring organic matter, or any combination thereof.

13. A system for purifying water, the system comprising: a gel composition comprising: (i) a 3D microporous gel skeleton; (ii) a plurality of polydopamine (PDA) nanoparticles adhered to the outer surface of the gel skeleton; and (iii) an outer layer comprising sodium alginate.

14. The system of claim 13, wherein the gel composition, when immersed into contaminated water, absorbs water while repelling one or more of the contaminants in the water, resulting in a gel composition in a hydrophilic swollen state containing purified water.

15. The system of claim 14, wherein the gel composition in a swollen state, when exposed to sunlight, transitions to a hydrophobic state, thereby expelling the purified water.

16. The system of claim 13, further comprising one or more of the following:
(a) a porous plate configured to contact the gel composition before and during its hydrophilic swollen state; or
(b) a receptacle configured to catch the purified water when it is expelled from the gel composition.
